(19) United States
(12) Patent Application Publication
(10) Pub. No.: US 2015/0381562 A1
(43) Pub. Date: Dec. 31, 2015

(54) METHOD AND SYSTEM FOR DETECTING A CHANGE IN CONTACT INFORMATION

(71) Applicant: VONAGE NETWORK LLC, Holmdel, NJ (US)

(72) Inventors: Tzahi Efrati, Hoboken, NJ (US); Soheil Karshenas Najafabadi, Kew Gardens, NY (US)

(21) Appl. No.: 14/265,934

(22) Filed: Apr. 30, 2014

(51) Int. Cl. H04L 29/12; H04W 8/04; H04W 12/06

(52) U.S. Cl. CPC H04L 61/1594; H04W 12/06; H04W 8/04; H04L 61/6054

(57) ABSTRACT

Methods and systems for detecting a change in contact information are provided herein. In some embodiments, a method for detecting a change in contact information may include sending a request including a communication identifier stored in an address book associated with a first user, receiving, responsive to the request, a first identifier associated with the communication identifier, and comparing the first identifier received with a second identifier stored in association with the communication identifier.

### BACKGROUND OF THE INVENTION

1. Field of the Invention

Embodiments of the present invention generally relate to telecommunication systems and, more particularly, to a method and system for detecting a change in contact information.

2. Description of the Related Art

Telephony service providers and/or mobile app developers may wish to provide telephony services to an end user through an app. For example, telephony service providers may provide over the top (OTT) mobile apps that users can install on their smartphone, or other type of mobile devices, that allow users to make Voice over IP (VoIP) calls from their mobile phone.

These OTT mobile apps may aggregate contacts from a user's device, or from multiple devices associated with a user, and maintain access to a cloud address book with all the aggregated contact information. The cloud address book function, or contact directory, may include contact information about numerous contacts. Contact information generally includes information that can be used for contacting, corresponding with or otherwise communicating with a contact. Contact information may include, for example, the names, telephone numbers, e-mail addresses, mailing addresses, and other identifying information of a contact.

It may be difficult to determine which contact phone numbers are out of date or have otherwise gone stale. For example, contacts in a user's address book may no longer use certain phone numbers and those phone numbers may be re-provisioned/assigned to other subscribers.

Accordingly, there exists a need in the art for a convenient way to detect changes in contact information in order to alert a user that contact information may no longer be valid.

### SUMMARY OF THE INVENTION

Methods and systems for detecting a change in contact information are provided herein. In some embodiments, a method for detecting a change in contact information may include sending a request including a communication identifier stored in an address book associated with a first user, receiving, responsive to the request, a first identifier associated with the communication identifier, and comparing the first identifier received with a second identifier stored in association with the communication identifier.

In some embodiments, a system for detecting a change in contact information may include a contact storage device that stores a user's address book associated with a first user including a plurality of contact entries, each contact entry including a contact identifier, at least one communication identifier, and at least one unique first subscriber identifier stored in association with each other; and an authentication system including: a transmission module configured to: send a request including a communication identifier stored in the user's address book, and receive, responsive to the request, a second subscriber identifier associated with the communication identifier; and a verification module configured to compare the second subscriber identifier received with the first subscriber identifier stored in association with the communication identifier.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 depicts a block diagram of a system for detecting a change in contact information, according to one or more embodiments;

FIG. 3 depicts a flow diagram of a method for detecting a change in contact information, according to one or more embodiments; and

FIG. 4 depicts a computer system that can be utilized in various embodiments of the present invention, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to methods and apparatus for detecting a change in contact information. Specifically, a service provider that maintains an aggregated cloud address book for a user will periodically go through the address book and check the contact information in the address book to verify that it is still current. In some embodiments, this is done by checking whether a unique subscriber identifier (e.g., International Mobile Subscriber Identity (IMSI), and the like) that identifies a subscriber and correlates the subscriber with a specific phone number has changed. These unique subscriber identifiers can be checked by sending a query to the third party service provider/carrier that owns, or has otherwise provisioned, the phone number to the user. If the unique subscriber identifier has changed for a phone number listed in the user's address book, then the phone number may no longer be associated with the user's contact. The contact may then be marked/flagged and the user would be notified of the change. In some embodiments, the stale contact may automatically be deleted and other automatic actions may be performed.

Embodiments of the present invention may be used by Voice over Internet Protocol (VoIP) service providers and VoIP mobile apps used in providing VoIP telephony service. Those skilled in the art will appreciate that embodiments of the present invention can also be used with non-VoIP telephony mobile apps that may also benefit by detecting changes in contact information.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the following description, the terms VoIP system, VoIP telephony system, Internet protocol (IP) system and IP telephony system are all intended to refer to a system that connects callers and that delivers data, text and video communications using IP data communications. After a user subscribes to a VoIP service, the user can make/receive phone calls to/from other VoIP subscribers or to public switched telephone network (PSTN) customers and access a number of features associated with the VoIP service, such as call waiting, three-way calling, call forwarding, voicemail service, and the like.

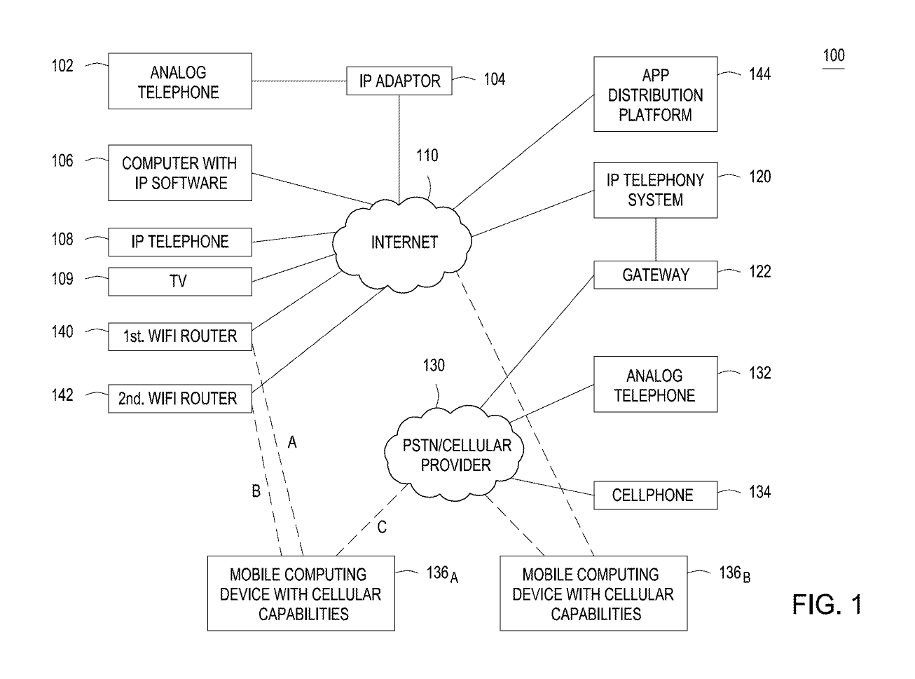

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a PSTN 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize the data channel of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 to place and receive IP based telephone calls, and to access other IP telephony systems (not shown). In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate calls over voice channels, and an IP telephone that can facilitate calls over data channels.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate mobile apps to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136 (e.g., a smartphone) is capable of establishing a first wireless data connection A with a first wireless access point 140, such as a WiFi or WiMax router. The first wireless access point 140 is coupled to the Internet 110. Thus, the mobile computing device 136 can establish a VOIP telephone call with the IP telephony system 120 via a path through the Internet 110 and the first wireless access point 140.

FIG. 1 also illustrates that the mobile computing device 136 can establish a second wireless data connection B with a second wireless access point 142 that is also coupled to the Internet 110. Further, the mobile computing device 136 can establish either a third wireless data connection C via a data channel provided by a cellular service provider 130 using its cellular telephone capabilities, or establish a telephone call via a voice channel provided by a cellular service provider 130. The mobile computing device 136 could also establish a VoIP telephone call with the IP telephony system 120 via the second wireless connection B or the third wireless connection C.

Although not illustrated in FIG. 1, the mobile computing device 136 may be capable of establishing a wireless data connection to a data network, such as the Internet 110, via alternate means. For example, the mobile computing device 136 might link to some other type of wireless interface using an alternate communication protocol, such as the WiMax standard.

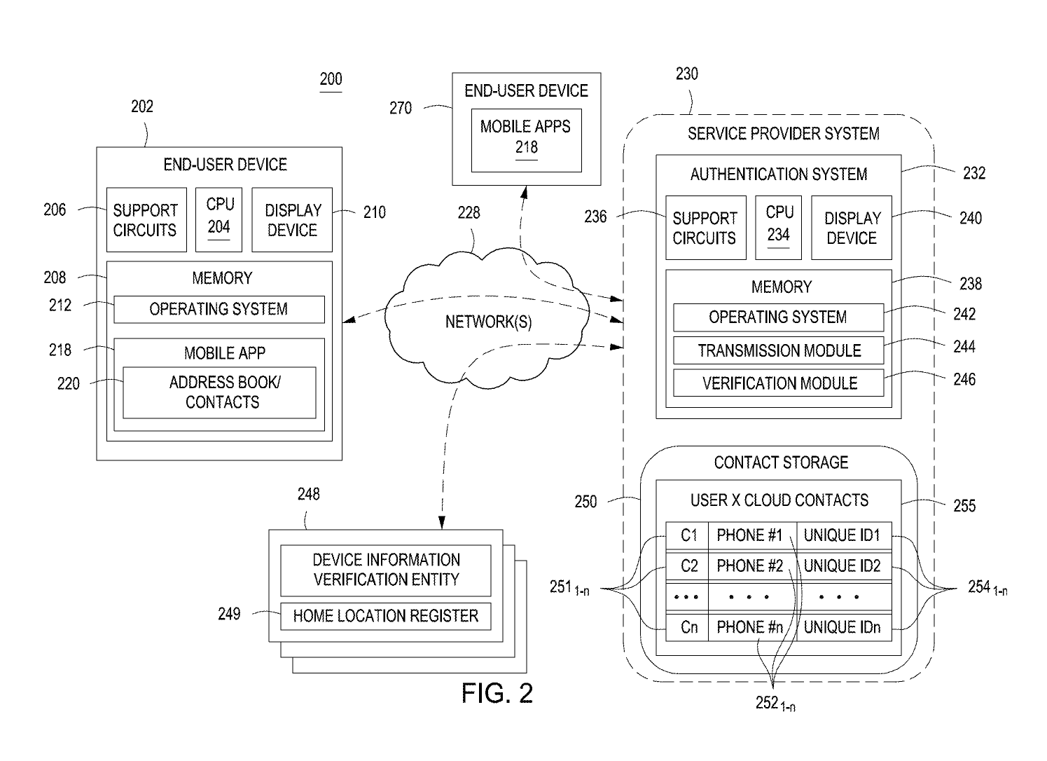

FIG. 2 depicts a block diagram of a system 200 for detecting a change in contact information, according to one or more embodiments. The system 200 comprises end-user device 202, service provider system 230, and a plurality of device information verification entities 248 communicatively coupled via networks 228. In some embodiments, end-user device 202 may be mobile computing device 136, and service provider system 230 may be IP telephony system 120 as described above in FIG. 1.

The end-user device 202 comprises a Central Processing Unit (CPU) 204, support circuits 206, memory 208, and the display device 210. The CPU 204 may comprise one or more commercially available microprocessors or microcontrollers that facilitate data processing and storage. The various support circuits 206 facilitate the operation of the CPU 204 and include one or more clock circuits, power supplies, cache, input/output circuits, and the like. The memory 208 comprises at least one of Read Only Memory (ROM), Random Access Memory (RAM), disk drive storage, optical storage, removable storage and/or the like. In some embodiments, the memory 208 comprises an operating system 212 and a mobile app 218.

The operating system (OS) 212 generally manages various computer resources (e.g., network resources, file processors, and/or the like). The operating system 212 is configured to execute operations on one or more hardware and/or software modules, such as Network Interface Cards (NICs), hard disks, virtualization layers, firewalls and/or the like. Examples of the operating system 212 may include, but are not limited to, various versions of LINUX, MAC OSX, BSD, UNIX, MICROSOFT WINDOWS, IOS, ANDROID and the like. In some embodiments, operating system 212 may include an application programming interface (API) which can be used to access and user device information and features (such as, for example, accessing unique subscriber identifiers, unique device identifiers, communication identifiers, and the like by mobile app 218).

In some embodiments, the mobile app 218 is a VoIP app that provides over-the-top (OTT) VoIP telephony services to an end-user. In some embodiments, OTT content describes broadband delivery of media/data/services without a traditional cellular service provider (e.g., PSTN provider 130) being involved in the control or distribution of the content itself. The provider may be aware of the contents of the IP packets but is not responsible for, nor able to control, the viewing abilities, copyrights, and/or other redistribution of the content. In other embodiments, the mobile app 218 may be a dedicated contact synchronization app.

The mobile app 218 can access user device information and features (such as, for example, accessing unique subscriber identifiers, unique device identifiers, communication identifiers, and the like) from the OS 212 via API calls. In some embodiments, the mobile app 218 of user device 270 may receive a request to provide user device information to verify contact information from the service provider system 230. The mobile app 218 on device 270 will send a response including the user/device information requested in response to the request. In addition, service providers who own/provisions phone numbers may partner with the OTT app provider to notify them when a contact is no longer valid. In some embodiments, an end-user may download the mobile app 218 from service provider system 230, or from an app distribution system associated with the service provider system 230, and install the mobile app 218 on their device (e.g., device 202 and device 270). Although the mobile app 218 is described herein as a separate stand-alone application, in some embodiments the mobile app 218 may be integrated into OS 212, and may use existing API calls provided by the OS 212 to access or control various features of the end-user device 202. In some embodiments mobile app 218 may include an address book 220.

The networks 228 comprise one or more communication systems that connect computers by wire, cable, fiber optic and/or wireless link facilitated by various types of well-known network elements, such as hubs, switches, routers, and the like. The networks 228 may include an Internet Protocol (IP) network (such as internet 110 of FIG. 1), a public switched telephone network (PSTN) (such as the PSTN network of PSTN provider 130 of FIG. 1), or other mobile communication networks, and may employ various well-known protocols to communicate information amongst the network resources.

In some embodiments, service provider system 230 may be a VoIP service provider or a mobile app developer. Service provider system 230 may include an authentication system 232 that may be used to verify the authenticity of the device information provided by end-user device 202. The authentication system 232 comprises a Central Processing Unit (CPU) 234, support circuits 236, memory 238, and an optional the display device 240. The CPU 234 may comprise one or more commercially available microprocessors or microcontrollers that facilitate data processing and storage. The various support circuits 236 facilitate the operation of the CPU 234 and include one or more clock circuits, power supplies, cache, input/output circuits, and the like. The memory 238 comprises at least one of Read Only Memory (ROM), Random Access Memory (RAM), disk drive storage, optical storage, removable storage and/or the like. In some embodiments, the memory 208 comprises an operating system 242, transmission module 244, and verification module 246. The operating system (OS) 242 generally manages various computer resources (e.g., network resources, file processors, and/or the like). The operating system 242 is configured to execute operations on one or more hardware and/or software modules, such as Network Interface Cards (NICs), hard disks, virtualization layers, firewalls and/or the like. Examples of the operating system 242 may include, but are not limited to, various versions of LINUX, MAC OSX, BSD, UNIX, MICROSOFT WINDOWS, IOS, ANDROID and the like.

In some embodiments, device information verification entities 248 may be one or more different service providers that assign/provision phone numbers to subscribers for telephony service. The device information verification entities 248 may include home location registers (HLR) 249 that can provide authentication/verification information to service provider system 230 upon request (e.g., that provides a unique subscriber identifier for each phone number verification is requested for). A database containing pertinent data regarding subscribers authorized to use a global system for mobile communications (GSM) network. Some of the information stored in an HLR includes an international mobile subscriber identity (IMSI) or other unique subscriber identifier and an associated phone number (i.e., a Direct inward dialing (DID), mobile station international subscriber directory number (MSISDN), and the like) of each subscription. In some embodiments, as noted above, a mobile device (e.g., devices 202 and device 270) that has mobile app 218 installed on it may itself be a device verification entity that can provide authentication/verification information to service provider system 230 upon request (e.g., that provides a unique subscriber identifier, e.g. an IMSI, for a phone number included in the request).

An IMSI may be used to identify the user of a cellular network and is a unique identification associated with all cellular networks. It is stored as a 64 bit field and is sent by the phone to the network. It is generally a 15-digit number. The first 3 digits are the mobile country code (MCC), which designates the country of the mobile network operator. The second 2 or 3 digits are the mobile network code (MNC), which designates the particular mobile network operator in the country. The remaining digits are the mobile subscription identification number (MSIN), which identify a particular subscriber within the service provider's customer base. In some embodiments, the IMSI may be accessible, for example, through API calls made to the operating system 212. In some embodiments, a third-party authentication entity (e.g., such as device information verification entities 248) would need to verify the IMSI with the end-user's service provider.

In some embodiments, the service provider 230 may be, or maintain, a database 250 that stores user address books 255 for each subscriber that associates contact identifiers 251₁₋ₙ (e.g., John, Mary, etc.), communication identifiers (e.g., phone numbers, etc.) 252₁₋ₙ and unique subscriber identifiers 254₁₋ₙ (e.g., IMSI, etc.) of end users. In some embodiments, subscriber identifiers other than an IMSI, but that have similar unique properties as an IMSI, may be used as the unique subscriber identifiers 254₁₋ₙ. For example, any identifier that is unique among all cellular networks to identify a user may be used. Contact identifiers 251₁₋ₙ are identifiers used to differentiate contacts within an address book, for example, such as a contact name or other identifier. Database 250 may be any data structure or data source that maintains an association of contact identifiers 251₁₋ₙ, communication identifiers 252₁₋ₙ and unique subscriber identifiers 254₁₋ₙ. The service provider system 230 may have direct or indirect access to database 250. For example, database 250 may exist on the service provider system 230 (direct access), or be accessible through a third party network (indirect access). For example, the service provider system 230 may be a VoIP service provider or a mobile app developer that provides OTT telephony services and may have agreements with trusted third-party providers to allow access to IMSI-phone number association databases. It is also possible to have similar arrangements with other entities (such as corporate enterprise services administrators) for IMSI-phone number association databases. The user address books 255 may also flag, or otherwise store indicators associated with, each contact identifier 252 associated with a device (e.g., device 270) that has mobile app 218 installed on it. For example, if mobile app 218 is a VOIP app provided by the service provider 230, additional services/access may be provided for subscribers/devices that use mobile app 218.

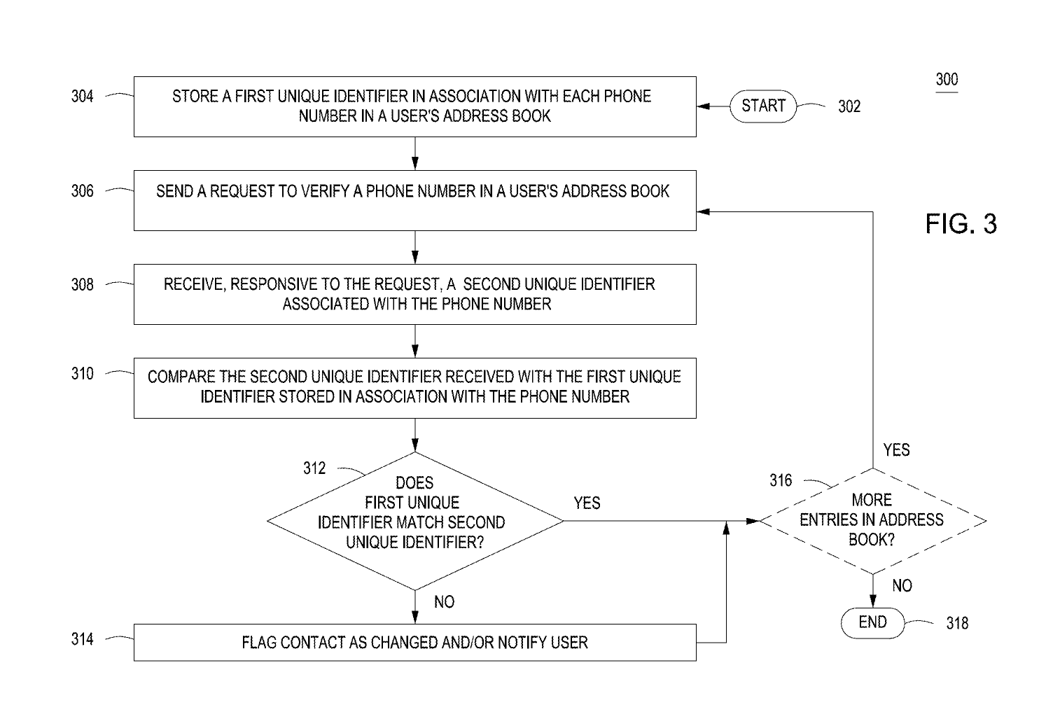

Exemplary methods that may be performed by one or more elements of system 200 for verifying authenticity of device information of an end-user device are described below with respect to FIG. 3. FIG. 3 depicts a flow diagram of a method 300 verifying authenticity of device information of an end-user device. In some embodiments, the method 300 may be performed by service provider system 230 (e.g., by authentication system 232 and contact storage 250), while in other embodiments the method 300 may be performed by an end-user device 202.

The method 300 starts at 302 and proceeds to 304. At 304, contact storage 250 may store a unique subscriber identifier 254₁₋ₙ in association with each phone number/communication identifier 252₁₋ₙ in a user's cloud based address book. In some embodiments, the user's address book 255 is an aggregated cloud address book that includes contact information obtained from one or more devices associated with the user, such as, for example, from address book 220 on user device 202. In some embodiments, the user may enter contacts directly into their cloud contact address book 255. As discussed above, the unique subscriber identifiers 254₁₋ₙ may include IMSIs and the like. After a list of phone numbers/communication identifiers 252₁₋ₙ is obtained, authentication system 232 may retrieve unique subscriber identifiers 254₁₋ₙ for each phone number 252₁₋ₙ from the device information verification entities 248 that own, or otherwise assigned/provision, the communication identifiers 252 to the user. In some embodiments, before the authentication system 232 retrieves the unique subscriber identifiers 254₁₋ₙ, the list of phone numbers/communication identifiers 252₁₋ₙ obtained may need to be normalized since the phone numbers in the user's address book may be in different formats (i.e., some may or may not include country codes, area codes, etc.) Thus, the communication identifiers 252₁₋ₙ may be normalized such that they are all in a standard format. For example, in some embodiments, the communication identifiers 252₁₋ₙ may be normalized or otherwise converted to an E.164 number, an E.212 number, or the like. In some embodiments, since only mobile device identifiers have IMSIs or other unique mobile subscriber identifiers associated with them, normalizing the communication identifiers 252₁₋ₙ may also include determining whether the communication identifiers 252₁₋ₙ are mobile device identifiers or land-line/fixed-line identifiers. The determination as to whether the communication identifiers 252₁₋ₙ are mobile device identifiers can be accomplished by checking with a third party service. For example, in the United States, all service providers can check with an administration center that handles all number portability requests and provide information regarding whether a phone number is a mobile device identifiers or land-line/fixed-line identifiers. Other types of public internet-based services are also available. In other countries, mobile device identifiers can be identified by the numeric range of the phone number. That is, in some countries, all mobile device identifiers have a phone number with specified numeric ranges. Communication identifiers 252₁₋ₙ that are determined to be a mobile device identifiers are flagged as such in the aggregated cloud address book 255 of the user.

At 306, a request is sent to device information verification entities 248 to determine if the phone number (e.g., 251₁) stored in a user's address book 255 is still associated with the same unique subscriber identifier (e.g., 254₁). In some embodiments, the request may be sent for each phone number included in the user's address book. In other embodiments, the request may be sent only for those phone numbers/communication identifiers 252₁₋ₙ that have been successfully normalized. In some embodiments, the request may be sent only for those phone numbers/communication identifiers 252₁₋ₙ that are flagged as a mobile device identifier to reduce the number of requests sent. In some embodiments, the request may be sent by transmission module 244. The request may include the phone number being verified in addition to other information to help identify the user. In some embodiments, the request may be sent periodically for each phone number in the user's address book 255. For example, the request may be sent once a week, once a month, or any other configurable time period set by the user or by a default time period set by service provider 230. In some embodiments, the request may only be sent for phone numbers 252 that have not been called or otherwise accessed for a predetermined time period. For example, if the default time period to check for changes in contact information is set to once a week, only those phone numbers that have not been accessed or called during that week will be verified to determine if the contact information is changed.

In some embodiments, the request is sent to a home location register (HLR) 249 of the device information verification entity 248 that owns/provisioned the phone number. The phone numbers 252 included in the user's address book 255 may be owned by different service providers. Thus, in some embodiments, the different requests may be sent to different HLRs depending on which service provider owns the phone number in question. In addition, for communication identifiers 252₁₋ₙ that are flagged as being associated with a second user device 270 having mobile app 218 installed on it, the request may be sent directly to device 270 to be processed by the mobile app 218 on device 270. The mobile app 218 will access user device information and features (e.g., IMSI) from the OS 212 via API calls. The mobile app 218 will send a response including the user/device information requested in response to the request.

At 308, a unique subscriber identifier, for example an IMSI, associated with the phone number sent in the request at 306 is received in a message/response responsive to the request sent at 306. In some embodiments, the response received may include the phone number in question and the associated unique subscriber identifier in addition to other information used to identify the user. In some embodiments, the response may be received from the HLR 249 associated with the device information verification entity 248 that owns the phone number. In some embodiments, the unique subscriber included in the response received may be encrypted.

At 310, the unique subscriber identifier received associated with phone number 252₁, for example, is compared with the stored unique subscriber identifier 254₁. If a stored unique subscriber identifier 254₁ does not exists (e.g., a first time query), then, in some embodiments, the unique subscriber identifier received is stored as the stored unique subscriber identifier 254₁. In some embodiments, the comparison is performed by verification module 246. If the received unique subscriber identifier is the same as the stored unique subscriber identifier 254₁ for phone number 252₁, than the method proceeds to 316 to determine if more contact book entries exist. If, however, the received unique subscriber identifier does not match the stored unique subscriber identifier 254₁ for phone number 252₁, the verification module 246 will determine that the phone number is stale and may have changed ownership (i.e., may be been assigned to another subscriber).

In some embodiments, when it is determined that the received unique identifier associated with the phone number is different than the unique identifier stored in association with the phone number (i.e., that the contact information has changed), an indicator will be stored in association with the phone number indicating a change in the contact information (e.g., that the phone number may be associated with a new user). In some embodiments, when it is determined that the received unique identifier associated with the phone number is different than the unique identifier stored in association with the phone number, a notification may be sent to the user device (e.g., user device 202) associated with the user indicating the phone number is now associated with a different subscriber and may be stale. In some embodiments, a notification message indicating the phone number's owner has changed may optionally be sent to partnering services. The method 300 then proceeds to 316.

In embodiments where all address book entries are checked, it may be optionally determined whether additional address book entries exist at 316. If it is determined that additional entries exist, the method returns to 306 where the method 300 is performed for each additional address book entries found. If, at 316, no more address book entries exist, in method 300 ends at 318.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

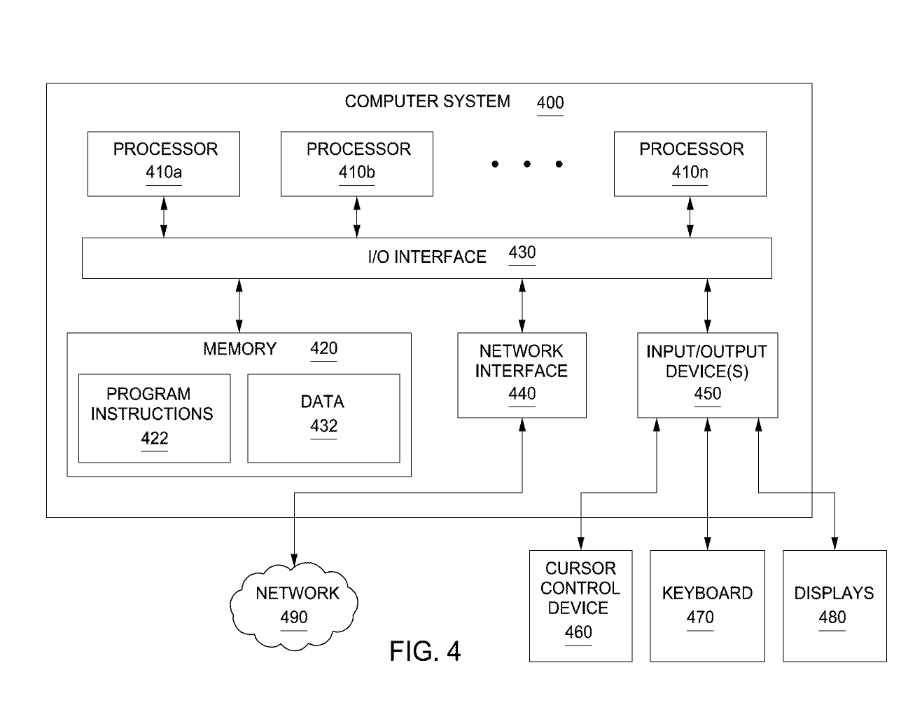

FIG. 4 depicts a computer system 400 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 400 illustrated by FIG. 4, which may in various embodiments implement any of the elements or functionality illustrated in FIGS. 1-3. In various embodiments, computer system 400 may be configured to implement methods described above. The computer system 400 may be used to implement any other system, device, element, functionality or method of the above-described embodiments. In the illustrated embodiments, computer system 400 may be configured to implement method 300 as processor-executable executable program instructions 422 (e.g., program instructions executable by processor(s) 410) in various embodiments.

In the illustrated embodiment, computer system 400 includes one or more processors 410a-410n coupled to a system memory 420 via an input/output (I/O) interface 430. Computer system 400 further includes a network interface 440 coupled to I/O interface 430, and one or more input/output devices 450, such as cursor control device 460, keyboard 470, and display(s) 480. In various embodiments, any of the components may be utilized by the system to receive user input described above. In various embodiments, a user interface may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 410 may be any suitable processor capable of executing instructions. For example, in various embodiments processors 410 may be general-purpose or embedded processors implementing any of a variety of instruction set architectures (ISAs). In multiprocessor systems, each of processors 410 may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one component (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 450 may, in some embodiments, include one or more display terminals, keyboards, keypads, touchpads, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the methods described above, such as the methods illustrated by the flowchart of FIG. 3. In other embodiments, different elements and data may be included.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for detecting a change in contact information, the method comprising:
sending a request including a communication identifier stored in an address book associated with a first user;
receiving, responsive to the request, a first identifier associated with the communication identifier; and
comparing the first identifier received with a second identifier stored in association with the communication identifier.

2. The method of claim 1, wherein the first and second identifiers are International Mobile Subscriber Identities (IMSIs).

3. The method of claim 1, further comprising:
determining that the first identifier is different than the second identifier.

4. The method of claim 3, further comprising:
storing a first indicator in association with the communication identifier indicating a change in the contact information.

5. The method of claim 3, further comprising:
sending a notification to a first user device associated with the first user indicating a change in the contact information.

6. The method of claim 1, wherein the request is sent periodically at a predefined time interval.

7. The method of claim 1, wherein the request is sent upon receiving a notification that the communication identifier was selected by the first user.

8. The method of claim 1, wherein the request is automatically sent when the communication identifier has not been called for a predetermined period of time.

9. The method of claim 1, wherein the address book associated with the first user is an aggregated address book that includes contact information from a plurality of contacts obtained from one or more devices associated with the user.

10. The method of claim 9, wherein the request is sent automatically for each of the contacts included in the aggregated address book at a predefined time interval.

11. The method of claim 1, further comprising:
normalizing the communication identifier prior to sending the request.

12. The method of claim 1, wherein the request is sent to a second user device associated with the communication identifier when the communication identifier associated with the second device has a second indicator stored in association with the communication identifier indicating that the second device has a specific type of mobile app installed on the second device.

13. The method of claim 1, wherein the request is sent to a home location register (HLR) of a service provider that provisioned the communication identifier, and wherein the response is received from the HLR of the service provider.

14. A system for detecting a change in contact information, comprising:
a contact storage device that stores a user's address book associated with a first user including a plurality of contact entries, each contact entry including a contact identifier, at least one communication identifier, and at least one unique first subscriber identifier stored in association with each other; and
an authentication system including:
a transmission module configured to:
send a request including a communication identifier stored in the user's address book, and
receive, responsive to the request, a second subscriber identifier associated with the communication identifier; and
a verification module configured to compare the second subscriber identifier received with the first subscriber identifier stored in association with the communication identifier.

15. The system of claim 14, wherein the first and second subscriber identifiers are International Mobile Subscriber Identities (IMSIs).

16. The system of claim 14, wherein, upon determining that the second subscriber identifier is different than the first subscriber identifier stored in association with the communication identifier, the verification module is further configured to store a first indicator in association with the communication identifier indicating a change in the contact information.

17. The system of claim 14, wherein, upon determining that the second subscriber identifier is different than the first subscriber identifier stored in association with the communication identifier, the verification module is further configured to send a notification to a first user device associated with the first user indicating a change in the contact information.

18. The system of claim 14, wherein the transmission module is configured to send the request periodically at a predefined time interval.

19. The system of claim 14, wherein the transmission module is configured to send the request upon receiving a notification that the communication identifier was selected by the first user.

20. The system of claim 14, wherein the transmission module is configured to send the request when the communication identifier has not been called for a predetermined period of time.

21. The system of claim 14, wherein the user's address book is an aggregated address book that includes contact information from a plurality of contacts obtained from one or more devices associated with the user.

22. The system of claim 21, wherein the transmission module is configured to send the request automatically for each of the contacts included in the aggregated address book at a predefined time interval.

23. The system of claim 14, wherein the authentication system is configured to normalize the communication identifier prior to sending the request.

24. The system of claim 14, wherein the transmission module is configured to send the request to a second user device associated with the communication identifier when the communication identifier associated with the second device has a second indicator stored in association with the communication identifier indicating that the second device has a specific type of mobile app installed on the second device.

25. The system of claim 14, wherein the transmission module is configured to send to a home location register (HLR) of a service provider that provisioned the communication identifier, and wherein the response is received from the HLR of the service provider.
